(19) United States
(12) Patent Application Publication
(10) Pub. No.: US 2023/0021108 A1
(43) Pub. Date: Jan. 19, 2023

(54) FILE STORAGE

(71) Applicant: Hitachi, Ltd., Tokyo (JP)

(72) Inventors: Akira YAMAMOTO, Tokyo (JP); Akifumi SUZUKI, Tokyo (JP)

(21) Appl. No.: 17/693,462

(22) Filed: Mar. 14, 2022

(30) Foreign Application Priority Data
Jul. 13, 2021 (JP) 2021-115973

(51) Int. Cl. G06F 16/174; G06F 16/172

(52) U.S. Cl. CPC G06F 16/1744; G06F 16/172

(57) ABSTRACT

A file storage include: a processor that receives a write request for a file from an application, writes data of the file to a storage unit, then compresses the data of the written file, and writes the compressed data to the storage unit. The processor determines a compression algorithm to be used for the compression according to an amount of data, which is written during a predetermined time, of one or more written files.

### CROSS-REFERENCE TO RELATED APPLICATION

The present application claims priority from Japanese application JP 2021-115973, filed on Jul. 13, 2021, the contents of which is hereby incorporated by reference into this application.

### BACKGROUND OF THE INVENTION

### 1. Field of the Invention

The present invention relates to a file storage having a batch compression function using a flash memory or a magnetic disk as a storage (storage medium).

### 2. Description of the Related Art

JP 2019-095913 A is a patent literature relating to an image-related compression algorithm. In recent years, with the explosive expansion of the amount of data, a technology for reducing the amount of data has been actively developed. In particular, research on compression algorithms relating to an image having a large data amount is active. A feature of such compression algorithms is that data loss due to lossy compression can be suppressed specifically for a specific application. For example, an image compressor can be created such that lost data is difficult to be recognized by a person.

The most important factor in the compression algorithm is a compression rate, which is a data reduction rate, but a compression speed is also important. In general, when an attempt is made to improve the compression rate, the compression speed decreases. In addition, a relationship between the increase or decrease of the compression rate and the increase or decrease of the compression speed is not linear, and when the compression rate is to be improved, the compression speed rapidly decreases. In addition, a decompression speed at the time of reading data is also generally reduced when the compression rate is high.

JP 2019-79113 A discloses an example of selecting a suitable compression algorithm according to an access frequency in a storage including a plurality of compression algorithms having different compression and decompression processing times.

### SUMMARY OF THE INVENTION

The compression of image data is often executed in units of files. The reason is that whether a type of data is still image data, moving image data, or audio data is determined in units of files. The compression algorithm to be applied is determined depending on the type of data. Therefore, a file storage which stores and reads data in units of files is caused to recognize the type of data, so that compression in units of files becomes possible.

In this case, it is desirable to apply a compression algorithm having the highest compression rate, but there is a restriction on the compression speed. In particular, when the compression process is executed at the time of storing data in the file storage, there is a possibility that a response performance to an application is significantly deteriorated.

The present invention has been made in view of the above points, and an object of the present invention is to propose a file storage or the like capable of increasing a data reduction rate without deteriorating a response performance at a time of storing data.

In order to solve such a problem, in the present invention, there is provided a file storage including: a processor that receives a write request for a file from an application, writes data of the file to a storage unit, then compresses the data of the written file, and writes the compressed data to the storage unit. The processor determines a compression algorithm to be used for the compression according to an amount of data, which is written during a predetermined time, of one or more written files.

According to the above configuration, the data of the written file is compressed later. Thus, for example, the data reduction rate can be increased without deteriorating the response performance at the time of storing the data.

According to the present invention, it is possible to increase the data reduction rate without deteriorating the response performance at the time of storing data.

### BRIEF DESCRIPTION OF THE DRAWINGS

FIG. 1 is a diagram illustrating an example of a configuration of an information system according to a first embodiment;

FIG. 2 is a diagram illustrating an example of a configuration of a file storage according to the first embodiment;

FIG. 3 is a diagram illustrating an example of information stored in a shared memory according to the first embodiment;

FIG. 4 is a diagram illustrating an example of a format of file storage information according to the first embodiment;

FIG. 5 is a diagram illustrating an example of a format of file information according to the first embodiment;

FIG. 6 is a diagram illustrating an example of a format of storage unit information according to the first embodiment;

FIG. 7 is a diagram illustrating an example of a format of real page information according to the first embodiment;

FIG. 8 is a diagram illustrating an example of file information to be in an empty state managed by an empty file information pointer according to the first embodiment;

FIG. 9 is a diagram illustrating an example of real page information in an empty state managed by empty page information according to the first embodiment;

FIG. 10 is a diagram illustrating an example of a management state of file information to which a cache area managed by an LRU head pointer and an LRU tail pointer is allocated according to the first embodiment;

FIG. 11 is a diagram illustrating an example of a structure of real page information managed by a receive timing head pointer and a receive timing tail pointer to the first embodiment;

FIG. 12 is a diagram illustrating an example of a program stored in a main storage (main memory) according to the first embodiment and executed by a processor;

FIG. 13 is a diagram illustrating an example of a processing flow of a write processing part according to the first embodiment;

FIG. 14 is a diagram illustrating an example of a processing flow of a read processing part according to the first embodiment; and

FIG. 15 is a diagram illustrating an example of a processing flow of a compression processing part according to the first embodiment.

### DESCRIPTION OF THE PREFERRED EMBODIMENTS

Hereinafter, an embodiment of the present invention will be described in detail. However, the present invention is not limited to the embodiments.

In view of a reduction rate of data in a file storage, it is desirable to apply a compression algorithm having the highest compression rate, but there is a restriction on a compression speed. In particular, when the compression process is executed at the time of storing data in the file storage, there is a possibility that a response performance to an application is significantly deteriorated.

When compression is performed using a compression algorithm of a compression speed equal to or lower than a data generation speed in a certain period of time, the compression cannot be performed in time, uncompressed data accumulates, and a capacity cannot be reduced.

Also when compressed data is read, if a decompression speed is slow, the response performance to an application may be significantly deteriorated as in the case of storage.

In this embodiment, the problem of the deterioration of the response performance at the time of data storage is solved when the file storage executes the compression process later together in a batch process.

By preparing a plurality of compression algorithms having different compression speeds, grasping a data generation amount per unit time of a file group that executes a compression process, and selecting a compression algorithm from among compression algorithms that can complete the compression process within an allowable time, an effective data reduction rate can be achieved.

In order to cope with the performance deterioration of the read processing, a cache area is provided in the file storage, and a decompressed file is stored in the cache area. When there is a read request, if the file hits the cache area, the decompressed data is directly read from the cache area. Accordingly, the problem of deterioration of the read performance of a file having a high read frequency is solved.

Next, an embodiment of the present invention will be described with reference to the drawings. The following description and drawings are examples for describing the present invention, and are omitted and simplified as appropriate for the sake of clarity of description. The present invention can be implemented in various other forms. Unless otherwise specified, each component may be singular or plural.

In this specification and the like, notations such as “first”, “second”, “third”, and the like are given to identify the components, and do not necessarily limit the number or order. In addition, the numbers for identifying the components are used for each context, and the numbers used in one context do not necessarily indicate the same configuration in another context. In addition, it does not prevent a component identified by a certain number from also functioning as a component identified by another number.

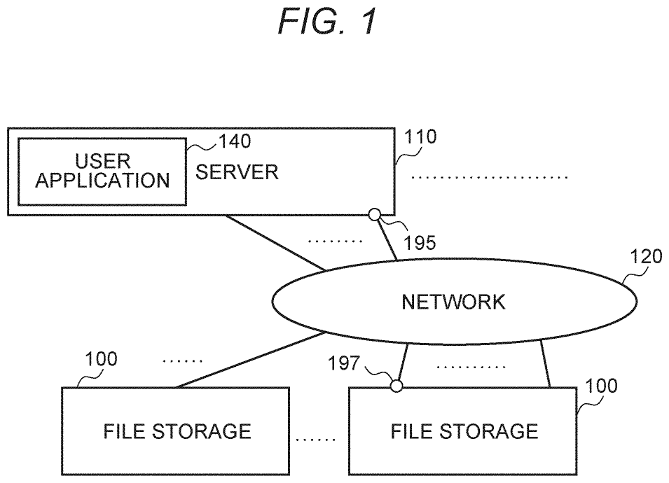

FIG. 1 illustrates a configuration of an information system according to the present invention. The information system includes one or more file storages 100, one or more servers 110, and a network 120 that connects the file storages 100 and the servers 110. The server 110 is connected to the network through a server port 195, and the file storage 100 is connected to the network 120 through a storage port 197. The server 110 has one or more server ports 195, and the file storage 100 has one or more storage ports 197 connected to the network 120. The server 110 reads and writes necessary data from and to the file storage 100 via the network 120 according to a request of a user application 140 in a system in which the user application 140 operates. A protocol used in the network 120 is, for example, NFS or CIFS.

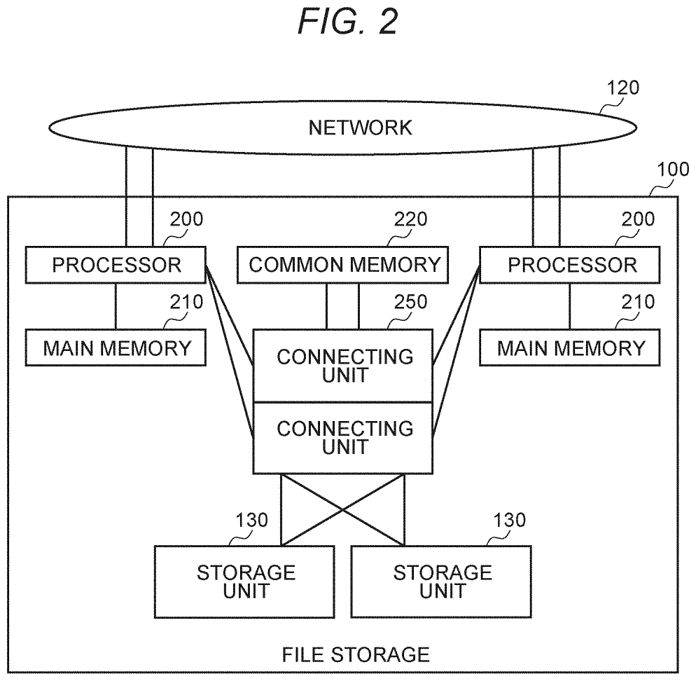

FIG. 2 illustrates a configuration of the file storage 100. The file storage 100 includes one or more processors 200, a main memory 210, a common memory 220, one or more connecting units 250 that connect these components, and a storage unit 130. In this embodiment, the file storage 100 includes the storage unit 130, and directly reads and writes data from and to the storage unit 130. However, the present invention is also effective in a configuration in which the file storage 100 does not include the storage unit 130 and reads and writes data by designating a logical volume (LUN or the like) with respect to a block storage including the storage unit 130. In addition, the present invention is also effective in a configuration in which the file storage 100 is mounted as software on the server 110 and operates in the same unit as the user application 140. In this case, the storage unit 130 is a unit connected to the server 110. The storage unit 130 includes the storage unit 130 such as a hard disk drive (HDD) and a flash storage using a flash memory as a storage medium, and the like. In addition, there are several types of flash storage, and there are an SLC with a high price, a high performance, and a large number of erasable times, and an MLC with a low price, a low performance, and a small number of erasable times. Furthermore, a new storage medium such as a phase change memory may be included. The processor 200 processes the read/write request issued from the server 110. The main memory 210 stores a program to be executed by the processor 200, internal information of each processor 200, and the like.

The connecting unit 250 is a mechanism that connects components in the file storage 100.

it is assumed that the common memory 220 is normally configured to be a volatile memory such as a DRAM, but becomes non-volatile by using a battery or the like. In addition, in this embodiment, it is assumed that each is duplicated for high reliability. However, the present invention is effective even when the common memory 220 is not non-volatilized or not duplicated. The common memory 220 stores information shared between the processors 200.

Incidentally, in this embodiment, it is assumed that the file storage 100 does not have a redundancy array independent device (RAID) function capable of recovering, even when one unit in the storage units 130 fails, the data of the one unit. Incidentally, the present invention is also effective when the file storage 100 has the RAID function.

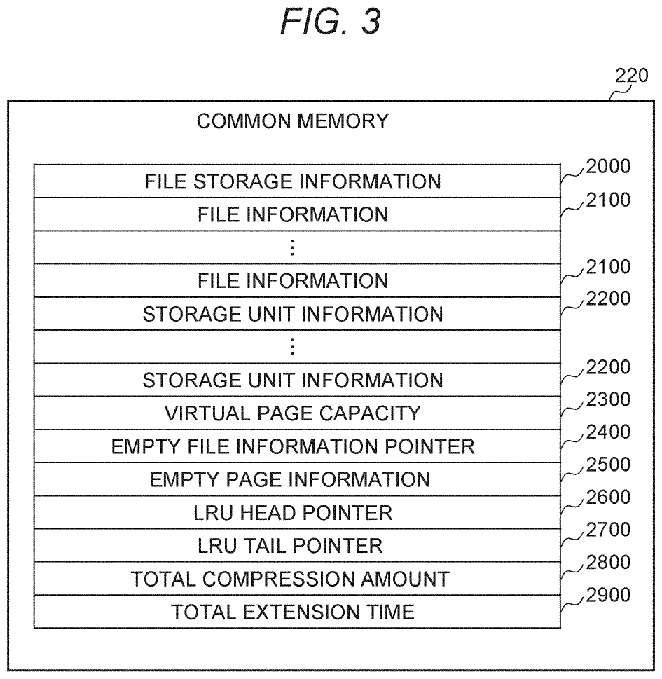

FIG. 3 illustrates information relating to this embodiment in the common memory 220 of the file storage 100 in this embodiment, and includes file storage information 2000, file information 2100, storage unit information 2200, a virtual page capacity 2300, an empty file information pointer 2400, empty page information 2500, an LRU head pointer 2600, an LRU tail pointer 2700, a total compression amount 2800, and a total decompression time 2900.

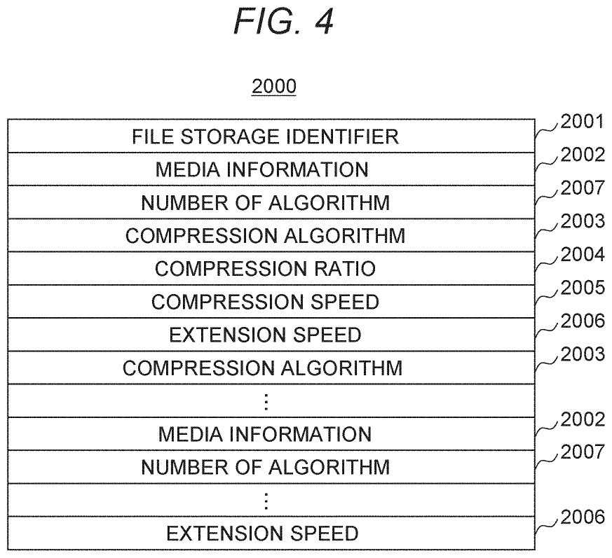

Among them, as illustrated in FIG. 4, the file storage information 2000 is information relating to the file storage 100, and includes a file storage identifier 2001, a media type 2002, the number of algorithms 2007, a compression algorithm 2003, a compression rate 2004, a compression performance 2005, and a decompression performance 2006. In this embodiment, it is assumed that when issuing a read/write request according to an instruction from the user application 140, the server 110 designates an identifier of the file storage 100, an identifier of the file, a relative address in the file, and a data length (the length of data to be read/written). The identifier of the file storage 100 designated by the read/write request is the file storage identifier 2001 included in the file storage information 2000. Furthermore, in this embodiment, it is assumed that the media information and compression information of the file are designated in the read/write request. Incidentally, the present invention is effective even when the media information and compression information of the file are notified by other means. The present invention targets a file storing media information, such as a moving image or an image, which can be expected to have a high compression rate and performs compression corresponding to media to reduce data. The media type 2002 indicates a type (a still image, a moving image, or the like) of media to be compressed by the file storage 100. The number of algorithms 2007 indicates the number of compression algorithms which this file storage 100 has for the corresponding media type. The compression algorithm 2003 indicates a compression algorithm which the relevant file storage 100 has. The compression rate 2004 and the compression performance 2005 indicate the compression ratio and the compression performance (speed) of the corresponding compression algorithm. In addition, the decompression performance 2006 indicates a decompression performance (speed). The compression algorithm 2003, the compression rate 2004, the compression performance 2005, and the decompression performance 2006 are repeated by the number set to the number of algorithms 2007. Thereafter, information relating to the media indicated by the next media type 2002 is set. The file storage 100 has one or more compression algorithms corresponding to the media type 2002. The media information designated in the read/write request indicates the media type of the relevant file, and the compression information indicates whether compression is performed or not and, in a case where compression is performed, the compression algorithm being used.

A feature of this embodiment is that the file storage 100 supports a capacity virtualization function. However, the present invention is effective even when the file storage 100 does not have the capacity virtualization function. Usually, in the capacity virtualization function, an allocation unit of a storage area is called a page. Incidentally, in this embodiment, it is assumed that a file space is divided in units of virtual pages, and the storage unit 130 is divided in units of real pages. In a case where the capacity virtualization function is realized, when a real page is not allocated to a virtual page including the address instructed to write by the write request from the server 110, the file storage 100 allocates the real page. The virtual page capacity 2300 is the capacity of the virtual page. In this embodiment, the virtual page capacity 2300 is equal to the capacity of the real page. However, the present invention is effective even when the real page includes redundant data, and the virtual page capacity 2300 is not equal to the real page capacity.

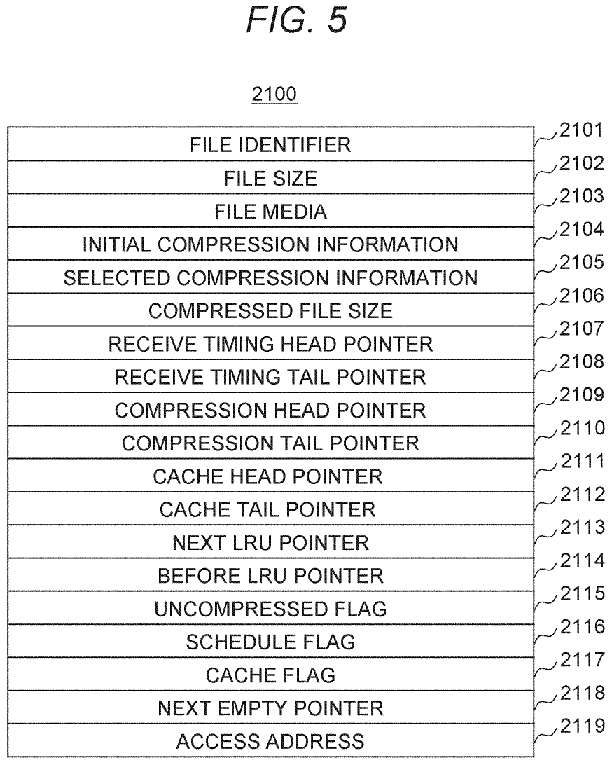

FIG. 5 illustrates a format of the file information 2100, and includes a file identifier 2101, a file size 2102, a file media 2103, initial compression information 2104, selected compression information 2105, a compressed file size 2106, a receive timing head pointer 2107, a receive timing tail pointer 2108, a compression head pointer 2109, a compression tail pointer 2110, a cache head pointer 2111, a cache tail pointer 2112, a next LRU pointer 2113, a before LRU pointer 2114, an uncompressed flag 2115, a schedule flag 2116, a cache flag 2117, a next empty pointer 2118, and an access address 2119.

In this embodiment, when receiving a read/write request from the server 110, the file storage 100 recognizes the corresponding file by the identifier of the designated file. The present invention targets a file storing media information, such as a moving image or an image, which can be expected to have a high compression rate. In addition, as the feature of such a file, in writing, data is added in order from a head address at a trigger of generating the file. Therefore, it is normal not to perform the rewriting of the area in which the writing is completed. In addition, when a file is read, the file is normally read from the beginning of the file to the end in address order.

The file identifier 2101 is an identifier of the relevant file. The file size 2102 is the amount of data written in the relevant file. The file media 2103 indicates the type of media of the relevant file, for example, the type of a moving image or the like. The initial compression information 2104 indicates a compression state of data initially written from the server 110. The initial compression information 2104 indicates whether compression is performed or not and, in a case where compression is performed, the compression algorithm being applied. In the present invention, a compression algorithm having a compression rate higher than that of the compression algorithm initially applied is applied later to improve the data reduction rate. The selected compression information 2105 indicates a compression algorithm to be applied later. The compressed file size 2106 indicates a file size when the selected compression information 2105 is applied. The receive timing head pointer 2107 and the receive timing tail pointer 2108 indicate a head page and a last page which stores the data for which the request is first received. The compression head pointer 2109 and the compression tail pointer 2110 indicate a head page and a last page in which the file storage 100 stores the compressed data. In the case of receiving a read request for data for which the file storage 100 stores the compressed data, it is necessary for the file storage 100 to convert the data into data initially written and then pass the data to the server 110. At this time, in the present invention, in order to ensure the response performance of a file having a high access frequency, the converted data is stored in the cache area provided in the storage unit 130. The cache head pointer 2111 and the cache tail pointer 2112 indicate the head page and the last page of the data stored in the cache area. When such control is performed, it is necessary to evict the data of a file with a lowered access frequency from the cache area. In the present invention, the LRU management of a file having data stored in the cache area is performed to determine a file to be evicted. The next LRU pointer 2113 and the before LRU pointer 2114 are a pointer to the file information 2100 of a file having an access frequency one higher than the relevant file and a pointer to the file information 2100 of a file having an access frequency one lower than the relevant file, respectively. The uncompressed flag 2115 is a flag indicating that the file storage 100 has not yet performed compression. The schedule flag 2116 is a flag indicating that the relevant file is set as a compression target. The cache flag 2117 indicates that the relevant file is being stored in the cache area. In the present invention, when a write request for a head address of a file is received, a write request for a new file is received. Thus, it is necessary to allocate the file information 2100 with this trigger. Therefore, it is necessary to manage the file information 2100 in an empty state. The next empty pointer 2118 is a pointer to file information next in an empty state. The access address 2119 indicates an address to be read next when compressed data is read in the file storage 100. Since the length of the compressed data is a variable length, the data in which the compressed data is stored cannot be generally calculated from the relative address designated by the read request. However, since the media data and the like are accessed in the order of addresses, the data to be accessed next is a next address even in the compressed data space. Thus, when this is stored, the address of the compressed data to be accessed in the next request can be recognized.

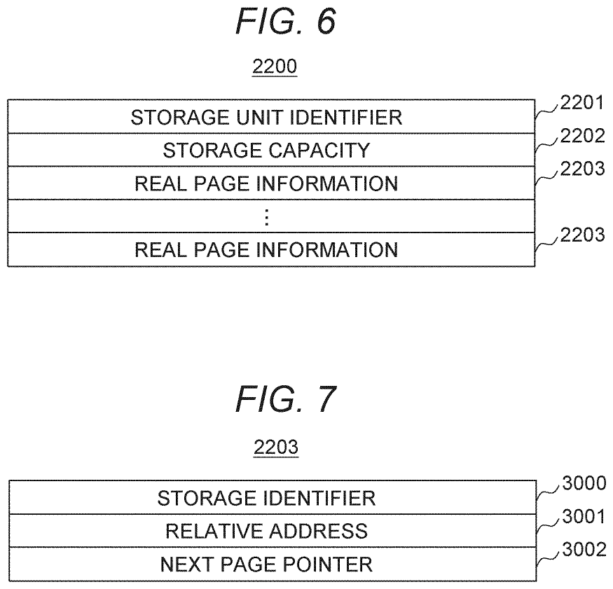

FIG. 6 illustrates the storage unit information 2200. The storage unit information 2200 has a storage unit identifier 2201, a storage capacity 2202, and real page information 2203. The storage unit identifier 2201 is the identifier of the relevant storage unit 130. The storage capacity 2202 is the capacity of the relevant storage unit 130. The real page information 2203 is information corresponding to the real page included in the relevant storage unit 130, and the number thereof is a value obtained by dividing the storage capacity by the virtual page capacity.

FIG. 7 illustrates a format of the real page information 2203. The real page information 2203 includes a storage identifier 3000, a relative address 3001, and a next page pointer 3002. The storage identifier 3000 indicates the identifier of the corresponding real page in the storage unit 130. The relative address 3001 indicates the relative address of the corresponding real page in the storage unit 130. In the present invention, the real page takes several states. The state is an empty state (unallocated) or an allocated state, the allocated state including a state in which data written first is stored, a state in which the compressed data is stored in the file storage 100, and a state in which the data is stored in the cache area, and thus there are total four states. Since the real pages in the same state are connected by the pointer, the next page pointer 3002 is a pointer to the next real page information 2203 in the same state.

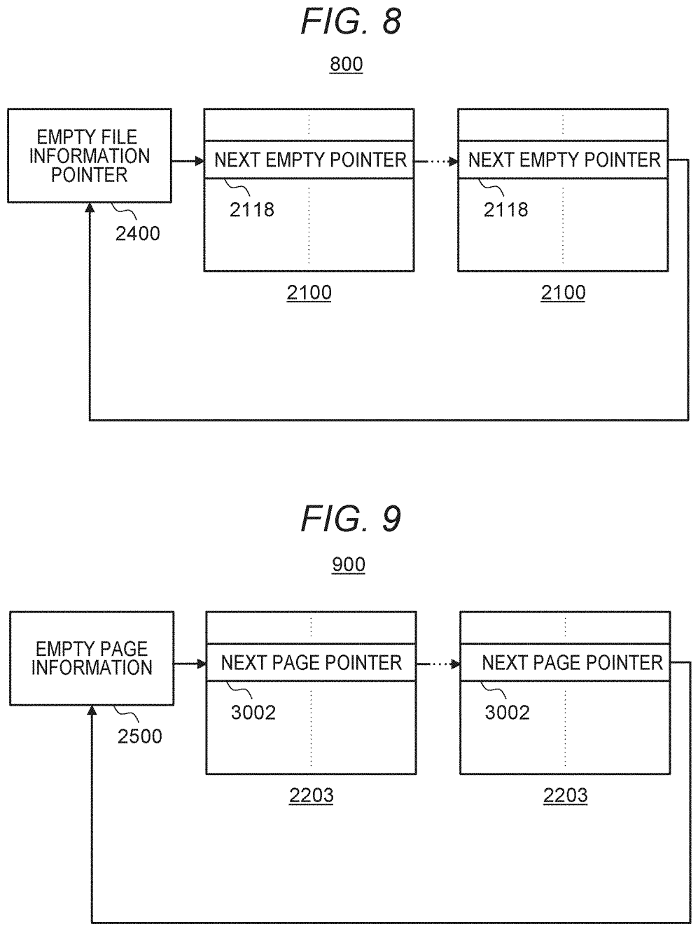

FIG. 8 illustrates the file information 2100 to be in the empty state managed by the empty file information pointer 2400. This queue is referred to as an empty file information queue 800. The empty file information pointer 2400 indicates the head file information 2100 in the empty state. The next empty pointer 2118 in the file information 2100 indicates the next file information 2100 in the empty state.

FIG. 9 illustrates the real page information 2203 in the empty state managed by the empty page information 2500. This queue is referred to as an empty real page information queue 900. The empty page information 2500 indicates the first real page information 2203 in the empty state. The next page pointer 3002 in the real page information 2203 indicates the next real page information 2203 in the empty state.

In the present invention, the file storage 100 periodically executes the compression process of the received file data. According to a feature of the present invention, an amount of data that needs to be compressed is grasped, and a compression algorithm for completing the compression process is selected by a next cycle. Accordingly, a compression algorithm having the highest data reduction effect can be applied within a range in which the compression process can be performed in time. The total compression amount 2800 is an amount of data for which the compression process needs to be performed in the relevant cycle. In addition, in the present invention, initially compressed data is allowed to be received. In this case, in order to apply a compression algorithm having a compression rate higher than that of the initial compression algorithm, it is necessary to decompress the data once. Therefore, in practice, it is necessary to make the compression process in time including this decompression time. The total decompression time 2900 is a total value of the time required for the decompression process.

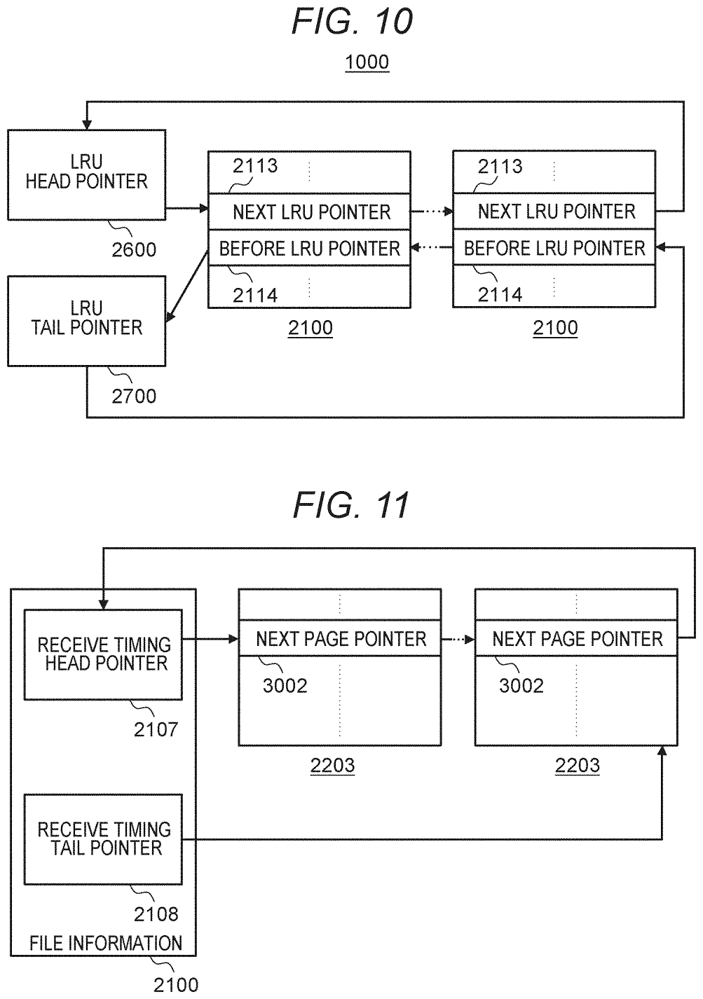

FIG. 10 illustrates a management state of the file information 2100 to which the cache area managed by the LRU head pointer 2600 and the LRU tail pointer 2700 is allocated. This queue is referred to as a file information LRU queue 1000. The file information 2100 indicated by the LRU head pointer 2600 is the file information 2100 of a recently read file, and the file information 2100 indicated by the LRU tail pointer 2700 is the file information 2100 of a file which has not been read for the longest period. When a file to which the cache area is allocated newly appears, the real page is released from the file information 2100 indicated by the LRU tail pointer 2700 and returned to the real page in the empty state managed by the empty page information 2500 illustrated in FIG. 9.

FIG. 11 illustrates a structure of the real page information 2203 managed by the receive timing head pointer 2107 and the receive timing tail pointer 2108. The receive timing head pointer 2107 indicates the real page information 2203 in which the data for which the request is first received, that is, the data of the head address of the file is stored. The next page pointer 3002 of the real page information 2203 indicates the real page information 2203 storing data of the next address of the file. The receive timing tail pointer 2108 stores the address of the real page information 2203 storing the data which is last received, that is, the data of the last address.

The structure of the real page information 2203 managed by the compression head pointer 2109 and the compression tail pointer 2110 and the structure of the real page information 2203 managed by the cache head pointer 2111 and the cache tail pointer 2112 are the same as the structure illustrated in FIG. 11, and thus, the description thereof will be omitted.

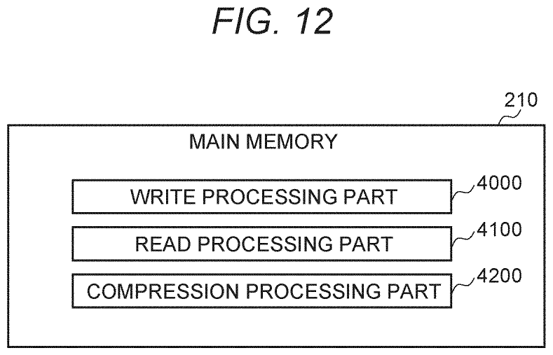

Next, the operation of the processor 200 of the file storage 100 will be described using the management information described above. The program executed by the processor 200 of the file storage 100 is stored in the main memory 210. FIG. 12 illustrates a program relating to this embodiment stored in the main memory 210. The programs according to this embodiment include a write processing part 4000, a read processing part 4100, and a compression processing part 4200.

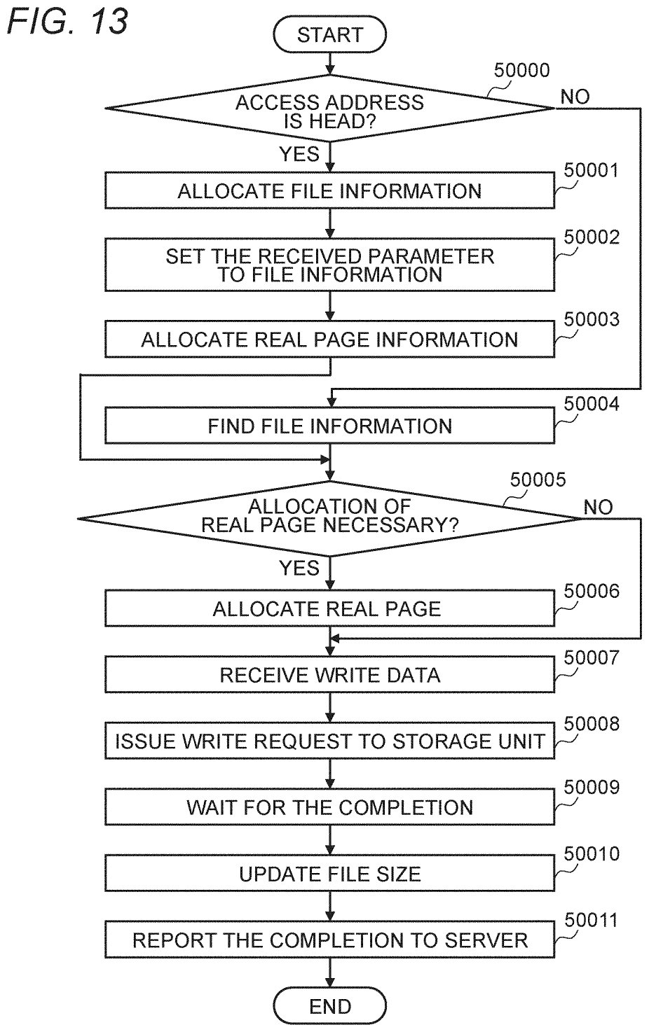

FIG. 13 illustrates a processing flow of the write processing part 4000. The processing flow of the write processing part 4000 is a processing flow executed when a write request is received from the server 110.

Step 50000: Check whether the designated relative address is the head address of the file. When it is not the head, the processing jumps to step 50004.

Step 50001: Allocate the file information 2100 indicated by the empty file information pointer 2400 to the relevant file. A value indicated by the next empty pointer 2118 of the allocated file information 2100 is set to the empty file information pointer 2400.

Step 50002: Set the identifier, the media type, and the compression information of the file designated in the write request in the file identifier 2101, the file media 2103, and the initial compression information 2104.

Step 50003: Make the real page information 2203 in the empty state indicated by the empty page information 2500 be indicated by both the receive timing head pointer 2107 and the receive timing tail pointer 2108 of the relevant file information. In addition, information indicated by the next page pointer 3002 of the allocated real page information 2203 is set as the empty page information 2500. Thereafter, the processing jumps to step 50005.

Step 50004: Find the corresponding file information 2100 on the basis of the file identifier designated in the write request.

Step 50005: Check whether data can be stored only with the currently allocated real page on the basis of the relative address and the data length of the received write request. If it can be stored, the processing jumps to step 50007.

Step 50006: The real page information 2203 (relevant real page information 2203) in the empty state indicated by the empty page information 2500 is indicated by the next page pointer 3002 of the real page information 2203 indicated by the receive timing tail pointer 2108. In addition, the relevant real page information 2203 is indicated by the receive timing tail pointer 2108. In addition, information indicated by the next page pointer 3002 of the relevant real page information 2203 (allocated real page information 2203) is set as the empty page information 2500.

Step 50007: Receive write data. On the basis of the relative address and the data length, it is calculated which address of which page data is to be written in.

Step 50008: Issue a write request to the storage unit 130.

Step 50009: Wait for completion.

Step 50010: Update the file size 2102 on the basis of the received data length.

Step 50011: Send a completion report to the server 110.

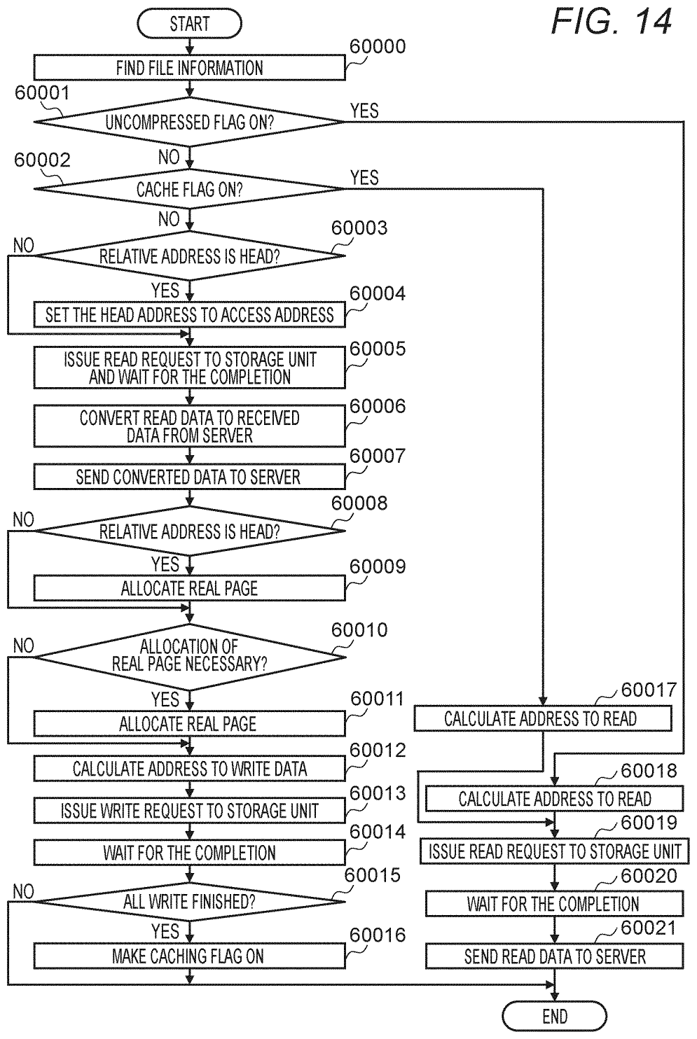

FIG. 14 illustrates a processing flow of the read processing part 4100. The processing flow of the read processing part 4100 is a processing flow executed when the file storage 100 receives a read request from the server 110.

Step 60000: Find the corresponding file information 2100 on the basis of the designated file identifier.

Step 60001: Check whether the uncompressed flag 2115 is on. If it is on, the processing jumps to step 60018.

Step 60002: Check whether the cache flag 2116 is on. If it is on, the processing jumps to step 60017.

Step 60003: Check whether the relative address designated in the read request is the head address, and if not, jump to step 60005.

Step 60004: Set the head address of the real page corresponding to the compression head pointer 2109 to the access address 2119 in the case of the head. In addition, the real page information 2203 allocated to the file information 2100 indicated by the LRU tail pointer 2700 illustrated in FIG. 10, that is, the real page information 2203 existing between the cache head pointer 2111 and the cache tail pointer 2112 of the file information 2100 is transferred to the empty real page information queue 900 indicated by the empty page information 2500. In addition, the cache flag 2117 of the file information 2100 is made off. Furthermore, the address of the file information 2100 indicated by the before LRU pointer 2114 in the file information 2100 indicated by the LRU tail pointer 2700 is set to the LRU tail pointer 2700.

Step 60005: Issue a read request to the storage unit 130 and await completion in order to read data from the address indicated by the access address 2119 in the page storing the compressed data.

Step 60006: Convert the read data into data received from the server 110 with reference to the selected compression information 2105 and the like of the file information 2100.

Step 60007: Send the converted data to the server 110, and report completion.

Step 60008: Check whether the designated relative address is the head address of the file. When it is not the head, the processing jumps to step 60010.

Step 60009: Make the real page information 2203 in the empty state indicated by the empty page information 2500 be indicated by both the cache head pointer 2111 and the cache tail pointer 2112 of the relevant file information. In addition, information indicated by the next page pointer 3002 of the allocated real page information 2203 is set as the empty page information 2500. In addition, the relevant file information 2100 is moved to the position indicated by the LRU head pointer 2600 illustrated in FIG. 10.

Step 60010: Check whether data can be stored only with the currently allocated real page on the basis of the relative address and the data length of the received read request. If it can be stored, the processing jumps to step 60012.

Step 60011: Make the real page information 2203 (relevant real page information 2203) in the empty state indicated by the empty page information 2500 be indicated by the next page pointer 3002 of the real page information 2203 indicated by the cache tail pointer 2112. In addition, the relevant real page information 2203 is indicated by the cache tail pointer 2112. In addition, information indicated by the next page pointer 3002 of the relevant real page information 2203 (allocated real page information 2203) is set as the empty page information 2500.

Step 60012: Calculate which address of which page data is to be written in on the basis of the received relative address and data length.

Step 60013: Issue a write request to the storage unit 130.

Step 60014: Wait for completion.

Step 60015: Update the access address 2119. Check whether writing of the entire file is completed. The processing ends in a case where the writing is not completed.

Step 60016: Make the cache flag 2117 on to complete the processing in the case of completion.

Step 60017: Recognize the address of the real page storing the data to be read with reference to the received relative address, the cache head pointer 2111, and the cache tail pointer 2112. The processing jumps to step 60019.

Step 60018: Recognize the address of the real page storing the data to be read with reference to the received relative address, the receive timing head pointer 2107, and the receive timing tail pointer 2108.

Step 60019: Issue a read request to the storage unit 130.

Step 60020: Wait until the reading is completed.

Step 60021: Send the read data to the server 110, and report ending. Thereafter, the processing ends.

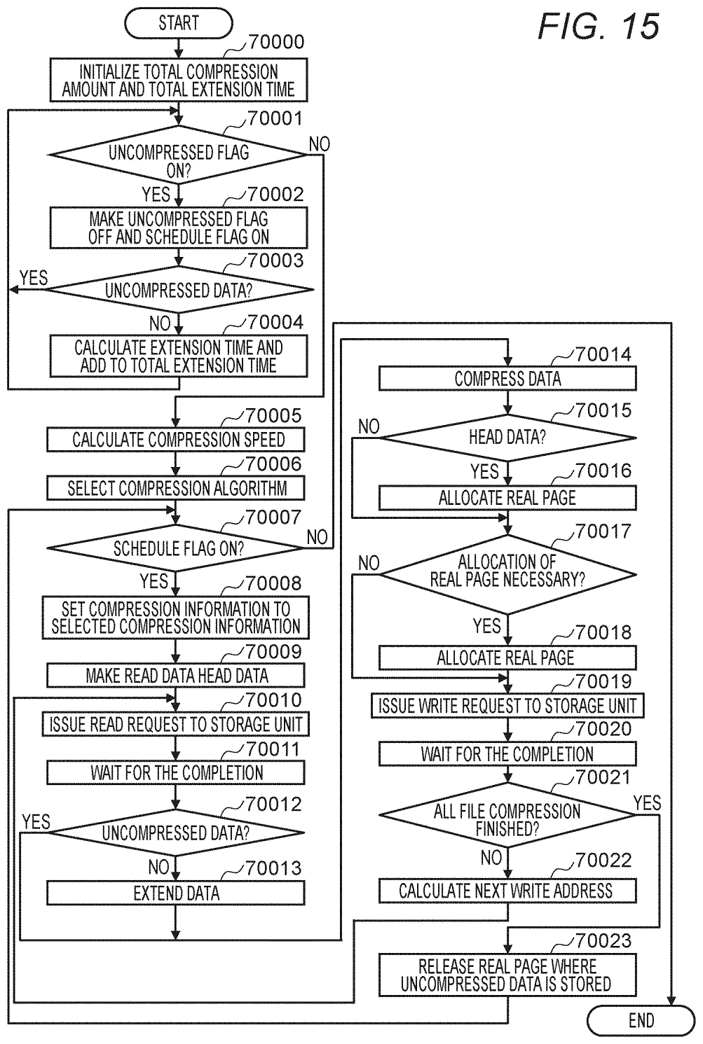

FIG. 15 illustrates a processing flow of the compression processing part 4200. The processing flow of the compression processing part 4200 is periodically started in the file storage 100.

Step 70000: Initialize the total compression amount 2800 and the total decompression time 2900.

Step 70001: Find the file information 2100 of which the uncompressed flag 2115 is on. In a case where the file information 2100 in which the uncompressed flag 2115 is on is not found, the processing jumps to step 70005.

Step 70002: Make the uncompressed flag 2115 of the found file information 2100 off and make the schedule flag 2116 on. The file size 2102 is added to the total compression amount 2800.

Step 70003: Jump to step 70001 when the initial compression information 2104 is not compressed.

Step 70004: In a case where there is compression, recognize the compression algorithm 2003 being used from the file media 2103 and the initial compression information 2104 and recognize the speed of decompressing this data by the corresponding decompression performance 2006. Furthermore, a value (=decompression time) obtained by multiplying this speed by the file size 2102 is added to the total decompression time 2900. Thereafter, the processing jumps to step 70001.

Step 70005: Subtract the total decompression time 2900 from the time until the next schedule. The compression process needs to be completed within the subtracted time. The total compression amount 2800 is divided by the subtracted value to calculate a necessary compression speed.

Step 70006: Determine, as the compression algorithm to be applied for each media type 2002, the compression algorithm 2003 having the highest compression rate among the compression algorithms 2003 that are held by the file storage 100 and are satisfying the compression speed.

Step 70007: Find the file information 2100 with the schedule flag 2116 on. If not found, the processing is completed.

Step 70008: Set the compression algorithm determined in step 70006 in the selected compression information 2105 with reference to the file media 2103.

Step 70009: Read the data stored in the real page corresponding to the real page information 2203 indicated by the receive timing head pointer 2107 and the receive timing tail pointer 2108. Here, the processing proceeds to the next step with the head data as a reading target.

Step 70010: Issue a read request to the storage unit 130 to read data to be read. In addition, the address of data to be read next is calculated.

Step 70011: Wait for completion.

Step 70012: Refer to the initial compression information 2104, and if there is no compression, jump to step 70014.

Step 70013: Recognize the compression algorithm applied in the initial compression information 2104 and perform the decompression process on the read data to return the data to an uncompressed state.

Step 70014: Compress the data by the compression algorithm to be applied with reference to the selected compression information 2105.

Step 70015: Check whether the current address is the head address of the file. When it is not the head, the processing jumps to step 70017.

Step 70016: Make the real page information 2203 in the empty state indicated by the empty page information 2500 be indicated by both the compression head pointer 2109 and the compression tail pointer 2110 of the relevant file information. In addition, information indicated by the next page pointer 3002 of the allocated real page information 2203 is set as the empty page information 2500. The address to be written in is set as the head of the allocated real page.

Step 70017: Check whether the data can be stored only with the currently allocated real page on the basis of the length of the compressed data. If it can be stored, the processing jumps to step 70019.

Step 70018: Make the real page information 2203 (relevant real page information 2203) in the empty state indicated by the empty page information 2500 be indicated by the next page pointer 3002 of the real page information 2203 indicated by the compression tail pointer 2110. In addition, the relevant real page information 2203 is indicated by the compression tail pointer 2110. In addition, information indicated by the next page pointer 3002 of the relevant real page information 2203 (allocated real page information 2203) is set as the empty page information 2500.

Step 70019: Issue a write request to the storage unit 130 in order to write the compressed data in the area recognized to be written in.

Step 70020: Wait for completion.

Step 70021: Check whether all the data of the file is completed, and in the case of completion, jump to step 70023.

Step 70022: Calculate an address to be written in next on the basis of the length of the compressed data. Thereafter, the processing jumps to step 70010.

Step 70023: Return all the real page information 2203 pointed by the receive timing head pointer 2107 to the empty real page information queue 900 indicated by the empty page information 2500. Thereafter, the processing returns to step 70007.

According to this embodiment, it is possible to improve the data reduction rate by selecting the compression algorithm to be applied according to the amount of data that needs to be compressed in the file storage that collectively executes compression later. In addition, in the file having a high access frequency, the response performance can be improved by caching temporarily decompressed data.

(Supplementary Note)

The above-described embodiment includes, for example, the following contents.

In the above-described embodiment, a case where the present invention is applied to the file storage has been described, but the present invention is not limited thereto, and can be widely applied to various systems, apparatuses, methods, and programs.

In the above-described embodiment, a case where the data in the cache area is managed in units of files has been described, but the present invention is not limited thereto. For example, the data in the cache area may be managed in units of read requests.

In the above-described embodiment, in a case where a first compression algorithm is received from an application, when a file read request is received from the application, a response is made to the application in such a manner that the data obtained when the data of the relevant file is compressed by a second compression algorithm is read from the storage unit, the read compressed data is decompressed by the second compression algorithm, and the decompressed data is compressed by the first compression algorithm. However, the present invention is not limited thereto. For example, in a case where the first compression algorithm is received from an application, when the file read request is received from the application, a response may be made to the application in such a manner that the data obtained when the data of the relevant file is compressed by the second compression algorithm is read from the storage unit, the read compressed data is decompressed by the second compression algorithm, and the decompressed data is compressed by a third compression algorithm different from the first compression algorithm.

The configuration of the above-described embodiment may be, for example, the following configuration.

(1) A file storage (for example, the file storage 100 and the server 110) includes a processor (for example, the processor 200) that receives a write request for a file from an application (for example, the user application 140), writes data of the file to a storage unit (for example, the storage unit 130), then compresses the data of the written file, and writes the compressed data to the storage unit (for example, the storage unit 130). In step 70006, the processor may determine a compression algorithm to be used for the compression according to an amount (for example, the total compression amount 2800) of data, which is written during a predetermined time, of one or more written files. In the file storage, for example, a sensor selects a compression method according to a data generation speed. In the storage unit, the generation speed of data generated by the sensor corresponds to the amount of data written during the predetermined time.

For example, in a case where a write data amount does not exceed a threshold, the processor determines a compression algorithm of a first compression speed, and in a case where the write data amount exceeds the threshold, the processor determines a compression algorithm of a second compression speed greater than the first compression speed. In addition, for example, the processor may determine the compression algorithm of the first compression speed in a time zone (for example, at night) in which the write data amount is small and determine the compression algorithm of the second compression speed higher than the first compression speed in a time zone (for example, daytime) in which the write data amount is large.

Here, the compression algorithm is, for example, an application program (compression software). In this case, the processor may change the setting related to the compression speed (compression rate) in the compression software and execute the compression software with the changed setting to compress the data, or may execute the determined compression software from a plurality of compression software having different compression speeds to compress the data.

According to the above configuration, the data of the written file is compressed later. Thus, for example, the data reduction rate can be increased without deteriorating the response performance at the time of storing the data.

(2) In the file storage according to (1), in step 70006, the processor may determine the compression algorithm used for the compression according to the amount of data, which is written during the predetermined time, of one or more written files and a compression speed (for example, the compression performance 2005) of each of a plurality of compression algorithms.

For example, in a case where 100 GB of data is written, the processor may determine a compression algorithm capable of compressing 100 GB of data within a predetermined time (for example, a periodic time such as a time designated in advance, a time from the end of the business related to the user application 140 to the start of the business, and every day).

According to the above configuration, for example, the compression algorithm having the highest compression rate can be determined from the compression algorithms having the compression speed higher than the data generation speed, so that it is possible to avoid a situation in which uncompressed data accumulates.

(3)

In the file storage according to claim 1), in step 50002, the processor may receive a media type (for example, the media type 2002) of data to be written in a file from the application, and in step 70006, the processor may determine the compression algorithm to be used for the compression according to the amount of data, which is written during the predetermined time, of one or more written files and the received media type.

For example, the processor determines different compression algorithms for moving image data, still image data, and audio data. In addition, in a case where the moving image data, the still image data, and the audio data are uncompressed data, the total write data amount is 4500 MB, and the available time for compression is 45 seconds, for example, the processor determines a compression algorithm with the highest compression rate from among compression algorithms that satisfy a compression speed of 100 MB/s for each of a moving image, a still image, and an audio. As such, the compression algorithm with an average compression speed may be determined. However, the method of determining the compression algorithm is not limited thereto.

According to the above configuration, for example, the compression algorithm suitable for the media type can be determined, and thus the data reduction rate can be further increased.

In addition, even when the media type is the same, in a case where data which is not deteriorated is transmitted from the application, the processor may determine a compression algorithm that gives priority to quality (an image quality, a sound quality, and the like), and in a case where data is transmitted with a reduced size from the application, the processor may determine a compression algorithm that does not give priority to quality.

(4) In the file storage according to (3), in step 70006, the processor may determine the compression algorithm to be used for the compression according to the amount of data, which is written during the predetermined time, of one or more written files, the received media type, and a compression speed of each of a plurality of compression algorithms.

According to the above configuration, for example, the compression algorithm having the highest compression rate can be determined from the compression algorithms having the compression speed higher than the data generation speed for each media type, so that it is possible to further increase the data reduction rate and avoid a situation in which uncompressed data accumulates.

(5) In the file storage according to (1), the processor receives, from the application, whether compression is performed on data transmitted from the application or not and, in a case where the compression is performed, a compression algorithm used (see, for example, step 50002 of FIG. 13).

In the above configuration, for example, in a case where the first compression algorithm is received from the application, the processor can decompress the compressed data transmitted from the application by using the first compression algorithm, compress the decompressed data by using the second compression algorithm having a compression rate higher than that of the first compression algorithm, and store the compressed data. Incidentally, in the above configuration, for example, when there is a read request from the application, the processor can respond to the application by decompressing the target data by the second compression algorithm and compressing the decompressed data by using the first compression algorithm.

For example, in a case where the first compression algorithm is received from the application, the processor may determine the second compression algorithm of a nature similar to the first compression algorithm. For example, the processor can determine the second compression algorithm in consideration of whether the compression of the first compression algorithm is lossless compression or lossy compression, so that the compression can be performed without impairing the nature of the data received from the application.

(6) In the file storage according to (5), in step 70006, the processor may determine the compression algorithm used for the compression according to the amount of data, which is written during the predetermined time, of one or more written files and a compression speed of each of a plurality of compression algorithms.

According to the above configuration, for example, a situation in which uncompressed data is accumulated can be avoided. Furthermore, according to the above configuration, for example, the compressed data transmitted from the application can be decompressed and compressed by the compression algorithm with a higher compression rate, so that the reduction rate of the compressed data transmitted from the application can be further increased.

(7) In the file storage according to (5), in step 70006, in a case where the written data is compressed data, the processor may determine the compression algorithm to be used for the compression according to a time (for example, the total decompression time 2900) for decompressing the data, the amount of data, which is written during the predetermined time, of one or more written files, and a compression speed of each of a plurality of compression algorithms.

According to the above configuration, for example, the processor can determine the compression algorithm in consideration of the time for decompressing the compressed data transmitted from the application, so that it is possible to avoid a situation in which the compressed data transmitted from the application and having a low compression rate accumulates.

(8) In the file storage according to claim (5), in step 50002, the processor may receive a media type of data to be written in a file from the application, and in step 70006, the processor may determine the compression algorithm to be used for the compression according to the amount of data, which is written during the predetermined time, of one or more written files and the received media type.

According to the above configuration, for example, the compression algorithm suitable for the media type can be determined, and thus the reduction rate of the compressed data transmitted from the application can be further increased.

(9) In the file storage according to (8), in step 70006, the processor may determine the compression algorithm to be used for the compression according to the amount of data, which is written during the predetermined time, of one or more written files, the received media type, and a compression speed of each of a plurality of compression algorithms.

According to the above configuration, for example, the reduction rate of the compressed data transmitted from the application can be further increased, and a situation in which uncompressed data accumulates can be avoided.

(10)

In the file storage according to (9), in a case where the written data is compressed data, in step 70006, the processor may determine the compression algorithm to be used for the compression according to a time for decompressing the data, the amount of data, which is written during the predetermined time, of one or more written files, the received media type, and a compression speed of each of a plurality of compression algorithms.

According to the above configuration, for example, the reduction rate of the compressed data transmitted from the application can be further increased, and a situation in which the compressed data transmitted from the application and having a low compression rate accumulates can be avoided.

(11)

A file storage (for example, the file storage 100 and the server 110) includes a processor (for example, the processor 200) that receives a write request for a file from an application (for example, the user application 140), writes data of the file to a storage unit (for example, the storage unit 130), then compresses the data of the written file, and writes the compressed data to the storage unit (for example, the storage unit 130). When receiving a read request for a file storing compressed data from an application, the processor decompresses the compressed data in step 60006, stores the decompressed data in a cache area in step 60013, determines whether or not data of the file for which the read request is received from the application exists in the cache area in step 60002, and, in a case where the data exists in the cache area, reads the data from the cache area in steps 60017 and 60019 and passes the read data to the application in step 60021.

According to the above configuration, for example, it is possible to increase the data reduction rate without deteriorating the response performance at the time of storing data, and to avoid a situation in which the reading performance of data of a file having a high reading frequency is deteriorated.

(12)

A file storage (for example, the file storage 100 and the server 110) includes a processor (for example, the processor 200) that receives a write request for a file from an application (for example, the user application 140), writes data of the file to a storage unit (for example, the storage unit 130), then compresses the data of the written file, and writes the compressed data to the storage unit (for example, the storage unit 130). The processor receives, from an application, whether compression is performed on data transmitted from the application or not and, in a case where the compression is performed, a compression algorithm used in step 50002, when receiving a read request for a file storing compressed data from an application, decompresses the compressed data in step 60006, and, in a case where the compression algorithm is received from the application, compresses the decompressed data by using the received compression algorithm and stores the compressed data in a cache area in step 60013, and determines whether or not data of the file for which the read request is received from the application exists in the cache area in step 60002 and, in a case where the data exists in the cache area, reads the data from the cache area in steps 60017 and 60019 and passes the read data to the application in step 60021.

According to the above configuration, for example, it is possible to increase the data reduction rate without deteriorating the response performance at the time of storing data, and to avoid a situation in which the reading performance of the compressed data of a file having a high read frequency is deteriorated.

The above-described configuration may be appropriately changed, rearranged, combined, or omitted without departing from the gist of the present invention.

What is claimed is:

1. A file storage comprising:
a processor that receives a write request for a file from an application, writes data of the file to a storage unit, then compresses the data of the written file, and writes the compressed data to the storage unit, wherein
the processor determines a compression algorithm to be used for the compression according to an amount of data, which is written during a predetermined time, of one or more written files.

2. The file storage according to claim 1, wherein
the processor determines the compression algorithm used for the compression according to the amount of data, which is written during the predetermined time, of one or more written files and a compression speed of each of a plurality of compression algorithms.

3. The file storage according to claim 1, wherein
the processor receives a media type of data to be written to a file from the application, and
determines the compression algorithm to be used for the compression according to the amount of data, which is written during the predetermined time, of one or more written files and the received media type.

4. The file storage according to claim 3, wherein
the processor determines the compression algorithm to be used for the compression according to the amount of data, which is written during the predetermined time, of one or more written files, the received media type, and a compression speed of each of a plurality of compression algorithms.

5. The file storage according to claim 1, wherein
the processor receives, from the application, whether compression is performed on data transmitted from the application and, in a case where the compression is performed, a compression algorithm used.

6. The file storage according to claim 5, wherein
the processor determines the compression algorithm used for the compression according to the amount of data, which is written during the predetermined time, of one or more written files and a compression speed of each of a plurality of compression algorithms.

7. The file storage according to claim 5, wherein
in a case where the written data is compressed data, the processor determines the compression algorithm to be used for the compression according to a time for decompressing the data, the amount of data, which is written during the predetermined time, of one or more written files, and a compression speed of each of a plurality of compression algorithms.

8. The file storage according to claim 5, wherein
the processor receives a media type of data to be written to a file from the application, and
determines the compression algorithm to be used for the compression according to the amount of data, which is written during the predetermined time, of one or more written files and the received media type.

9. The file storage according to claim 8, wherein
the processor determines the compression algorithm to be used for the compression according to the amount of data, which is written during the predetermined time, of one or more written files, the received media type, and a compression speed of each of a plurality of compression algorithms.

10. The file storage according to claim 9, wherein
in a case where the written data is compressed data, the processor determines the compression algorithm to be used for the compression according to a time for decompressing the data, the amount of data, which is written during the predetermined time, of one or more written files, the received media type, and a compression speed of each of a plurality of compression algorithms.

11. A file storage comprising:
a processor that receives a write request for a file from an application, writes data of the file to a storage unit, then compresses the data of the written file, and writes the compressed data to the storage unit, wherein
when receiving a read request for a file storing compressed data from an application, the processor decompresses the compressed data and stores the decompressed data in a cache area, and
the processor determines whether or not data of the file for which the read request is received from the application exists in the cache area and, in a case where the data exists in the cache area, reads the data from the cache area and passes the read data to the application.

12. A file storage comprising:
a processor that receives a write request for a file from an application, writes data of the file to a storage unit, then compresses the data of the written file, and writes the compressed data to the storage unit, wherein
the processor receives, from an application, whether compression is performed on data transmitted from the application or not and, in a case where the compression is performed, a compression algorithm used,
when receiving a read request for a file storing compressed data from an application, decompresses the compressed data, and in a case where the compression algorithm is received from the application, compresses the decompressed data by using the received compression algorithm and stores the compressed data in a cache area, and
determines whether or not data of the file for which the read request is received from the application exists in the cache area and, in a case where the data exists in the cache area, reads the data from the cache area and passes the read data to the application.
